(19) United States
(12) Patent Application Publication
(10) Pub. No.: US 2016/0328794 A1
(43) Pub. Date: Nov. 10, 2016

(54) METHODS AND SYSTEMS FOR IMPROVED APPLICATION SUBMISSIONS

(71) Applicant: PITCH POINT SOLUTIONS INC., Toronto (CA)

(72) Inventors: Stephen E. SCHRUMP, Mississauga (CA); Ron HUGHES, Ottawa (CA)

(73) Assignee: PITCH POINT SOLUTIONS, INC., TORONTO (CA)

(21) Appl. No.: 14/965,647

(22) PCT Filed: Jul. 24, 2014
(86) PCT No.: PCT/CA2014/000604

§ 371 Date: Dec. 10, 2015

Related U.S. Application Data
(60) Provisional application No. 61/857,773, filed on Jul. 24, 2013.

(51) Int. Cl. G06Q 40/02; H04L 29/06; G06F 17/30

(52) U.S. Cl. CPC G06Q 40/025; G06F 17/30867; H04L 63/08

(57) ABSTRACT

Disclosed are systems and methods for verifying data containing user-submitted information. Information entered into a form may be transmitted to a service provider associated with a transaction involving the user. The service provider may use a verification service implementing various data review and verification techniques described herein. Devices of the verification service may obtain public and private records about the user from one or more external databases. The devices of the verification service may identify which portions of information pertain to the user and the submitted data elements, and then determine whether the information in those submitted data elements matches with the records of the external databases. The devices of the verification service may generate a response in real-time (i.e., as the user is entering data in the capture form) or after the user completes the data element capture form.

### CROSS-REFERENCE TO RELATED APPLICATIONS

This non-provisional patent application is a U.S. national stage application of PCT International Application No. PCT/CA2014/000604, entitled “Methods and Systems for Improved Application Submissions,” filed Jul. 24, 2014, which claims the benefit of U.S. Provisional Patent Application Ser. No. 61/857,773, entitled “Methods and Systems for Improved Application Submissions,” filed Jul. 24, 2013, each of which are incorporated by reference herein in their entirety.

### TECHNICAL FIELD

This invention relates generally to improved systems and methods for application submissions.

### BACKGROUND

In a conventional mortgage application process, an applicant provides information to a lender about a home to be purchased as well as information about the applicant. Information about the applicant can include personal information (e.g., social security number, date of birth, address, former address, employment, previous employment), earnings statements (e.g., W-2 forms, pay stubs, and tax returns), verification of assets (e.g., bank account information, bond and stock information, motor vehicle title information), and debts (e.g., credit card bills, other loans, mortgage or rental payments, alimony or child support). A lender may request that the applicant use a Uniform Residential Loan Application (Form 1003), which is a lengthy form that requests personal information about the applicant.

Among one of the most significant compliance problems for lenders (application recipients) in the origination side takes place during the initial 1003 Application intake, with incomplete, erroneous and inconsistent/synonymous (applicant entries not syntactically equivalent to recognized public data sources due to various know aberrations such as nicknames, local shorthand, abbreviations, change of status [recently married, divorced, etc.], etc.) applicant information. As a result, applicants regularly struggle to complete the application, obtaining the information requested in the form, and/or complete each field correctly. As a result of the foregoing approximately two-thirds of mortgage applications contain unintentional errors, such as typographical errors, nick-names, local shorthand, and abbreviations, yet less than 1% of mortgage applications are part of a true fraud.

If any portion of the application is incomplete or incorrect, the applicant may be denied a loan by the lender. Further, due to the amount of information requested (often requiring hundreds of keystrokes), when using a computing device to complete the application, it may be challenging for an applicant to complete the application on a computing device with limited screen and key board size compared to a desktop or laptop computer. Moreover, when the entered information does not match the information stored in public databases, the applicant may be denied or the process may be delayed increasing the inconvenience to the applicant and the processing costs to the lender. Additionally, honest errors increase the cost and complexity of a fraud detection process for lenders, regulators and enforcement agencies due to the effort required to differentiate between the honest error and an intentional fraud attempt.

Conventional means for storing information relating to customers, or other individuals (e.g., employee, applicant), is usually done using internal databases of the service provider (e.g., bank, lender, employer). Customer information can be retrieved from these internal databases by querying the provider's various internal databases, and then information can be verified using the information retrieved from the internal databases. Often, however, a provider's internal databases do not have all of the requisite information relating to the customer, or a transaction for which the customer is submitting information to the service provider, as in the case of a loan application submittal. Because not all of the information is available to the provider's systems, the provider is unable to thoroughly check each of the entries submitted by the customer. The provider is also unable to cross-reference the submitted information against other types of data to determine whether the information is accurate or dynamically identify various data associations. What is needed is a means of retrieving data from a variety of external data sources in order to compare, dynamically cross-reference, and validate information inputted into electronically submitted forms or data fields.

Known conventional means of receiving information from various external and internal data sources often result in the requesting computer receiving the information in a number of different formats with respect to the originating databases. The varied formatting often causes the information to be difficult to correlate, cross-reference, manipulate and compare with respect to information submitted from a user and also with respect to each of the records retrieved from those originating databases. In some cases, this means that information of one record may not be appropriately cross-referenced or compared against information from another record or against the information submitted by the user. The data may not be accurately associated for appropriate comparisons. What is needed is a means for receiving data from various external data sources in which the data can be appropriately identified, parsed, and cross-referenced in order to identify whether submitted information from a user is accurate.

### SUMMARY

Systems and methods disclosed herein address the above-mentioned issues of the art, and provide a number of other advantages. A user may enter any number of data elements to an interface displaying a digital data entry form comprising of a number form fields. The information entered into the form may be captured as data elements that are then transmitted to a service provider associated with a transaction involving the user, such as an application for a loan. The service provider may operate or contract with a verification service implementing data review and verification techniques described herein, or variations thereof. Devices of the verification service may obtain public and private records about the user from a number of external databases. The devices of the verification service may identify which portions of information pertain to the user and the submitted data elements, and then determine whether the information in those submitted data elements matches with the records of the external databases. The devices of the verification service may generate a response in real-time (i.e., as the user is entering data in the capture form) or after the user completes the data element capture form.

In one embodiment, a computer-implemented method comprising receiving, by a computer, from a first computing device one or more data elements containing information about a person associated with a transaction; retrieving, by the computer, one or more records containing information about the person from two or more databases storing records containing information about one or more persons, wherein at least one of the two or more databases is an external database; comparing, by the computer, the information in each of the one or more data elements against the information contained in the one or more records; determining, by the computer, whether the information in each respective data element matches to the information contained in the one or more records; and for each respective data element containing information failing to match to the information in the one or more records: identifying, by the computer, a discrepancy in the information of the data element when a difference between the information in the data element and the one or more records exceeds a threshold.

In another embodiment, a system comprises a client device comprising a processor transmitting over a network one or more data elements containing the information about a person entered into one or more fields of a form on a user interface; two or more external databases comprising a non-transitory machine-readable storage medium storing records containing information about one or more persons; and a verification server comprising a processor receiving the one or more elements transmitted from the client device, retrieving one or more records containing information about the person from the two or more databases, determining whether the information in one or more fields of each respective record matches with each respective data element, identifying one or more unmatched data elements containing information failing to match a field of the one or more records, and for each unmatched data element: determining whether there is a discrepancy indicating that a difference between an unmatched data element and the data element in the record exceeds a discrepancy threshold.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a system overview according to an exemplary embodiment.

FIG. 2 illustrates a method for quality control according to an exemplary embodiment.

FIG. 3 illustrates a graphical user interface according to an exemplary embodiment.

FIG. 4 illustrates a method for applicant authentication and application completion according to an exemplary embodiment.

FIGS. 5 and 6 illustrate a graphical user interface according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

It is desirable to provide a system or method of submitting an application that attempts to resolve at least one of the deficiencies of the conventional processes. Although various exemplary embodiments herein describe a loan application for a mortgage, it is intended that the systems and methods may be applied to any application process, including an insurance application or another type of individual, joint, or commercial financial application (e.g., credit application, car loan or lease).

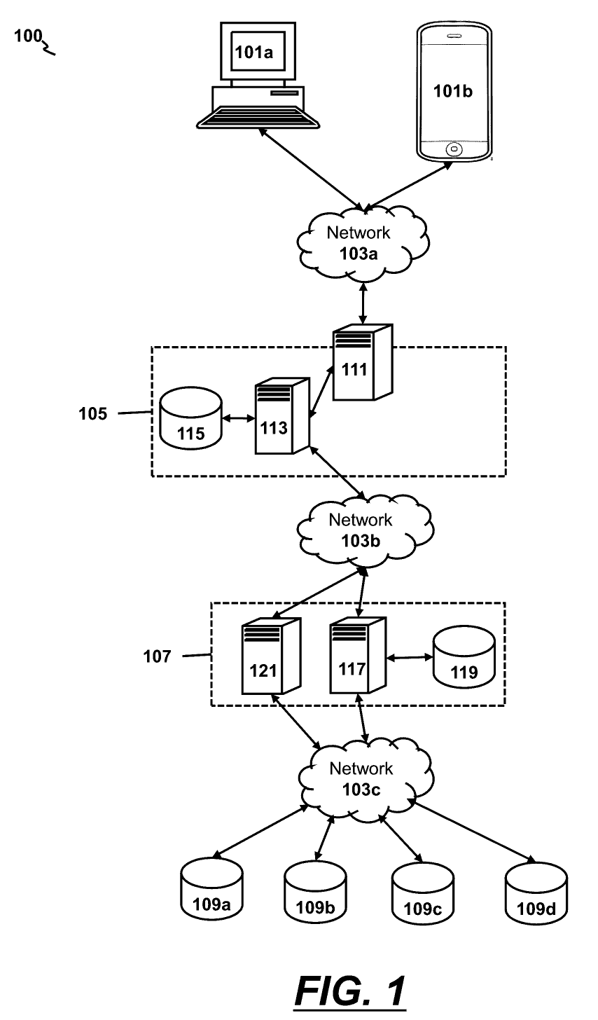

The methods described herein may be implemented on a computer readable medium, such as a client computer 101, a central server 113, or a verifier server 117, or other computing device not shown in FIG. 1. Computer readable media may include instructions that are executed by a processor to implement that particular functionality associated with those instructions. Although an exemplary embodiment provided herein may recite that software is stored and executed on a particular server, it is intended that any suitable computing device shown or contemplated can store or execute the described systems and methods.

### Exemplary System Embodiment

FIG. 1 shows an exemplary system 100 embodiment for verifying and validating information related to a transaction. The exemplary system 100 comprises a client device 101, one or more networks 103, a service provider network 105, a verifier network 107, and one or more external databases 109. The service provider network 105 comprises a web server 111, a central server 113, and an internal database 115. The verifier network 107 comprises an information review server 117, an aggregation server 119, and an authentication server 121.

Client-Side Information Submission

A client-computing device 101 may be any device comprising a processor executing software modules capable of performing the various tasks and processes described herein. In FIG. 1, the client computer device 101 is shown as a workstation 101a and as a smartphone 101b. However, the client computer device 101 may include any device capable of a wired or wireless connection, including a desktop computer, laptop computer, workstation, tablet computer, gaming console, personal data assistant, mobile phone, internet TV, ATM, CAT, in-branch terminal, or the like.

A computing device 101 may execute a software application providing a user interface (GUI) to allow the user interact with a server provider. The GUI may present the with a software-based form intended to capture information related to a particular transaction or review. In some embodiments, the software application may be a dedicated software product of the system 100 or an electronic document signing software tool (e.g., Adobe® Acrobat). In some embodiments, the software application may be a web-browser presenting the user with a web form (e.g., HTML form) or an embedded document signing software tool (e.g., Adobe® Acrobat). Using the GUI, the user may input information into one or more data fields of the soft form. In some embodiments, the user-inputted information may be parsed into data elements containing portions of the inputted information by a verifier server 117. Data elements may contain information associated with a particular field for categorizing the data element (e.g., address, first name, last name). The user-inputted information may be transmitted over a network 103 as a complete soft form, as a single data element, or as a block of one or more data elements. In some cases, information may be transmitted for review after completing all or part of a form. In other cases, a data element may be transmitted for review in real-time after the user enters the information for the data element.

In another embodiment, an applicant can initiate an automated completion of an application (e.g., Form 1003) using a mobile computing device, such as a smart phone or a tablet computer. The automated competition may implement the information retrieved from the external database, and may be done so for an entire application or on a field-by-filed basis. It should be appreciated that even though a mobile computing device is discussed in the exemplary embodiment, any computing device of the applicant may be used to initiate automated completion of an application. The device may also provide authentication information to a central server to log into the system. The device may also review, edit, and/or sign a completed application. The systems and methods aim to reduce keystrokes, thereby reducing errors.

Service Provider

A service provider network 105 may be a collection of computing devices that are networked together to privately communicate with one another via one or more networking protocols (e.g. TCP/IP) and networking devices (e.g., router, switch, firewall). The service provider network 105 may be a private network that only permits certain devices to communicate among the devices 111, 113, 115 of the service provider network 105. Such provider devices 111, 113, 115 may be a single physical computing device, or may be several computing devices. The server provider network 105 may comprise devices located at a number of physical locations, and thus the service provider network 105 may represent logical boundaries for an internal network. That is, the provider devices 111, 113, 115 may be geographically dispersed and so communicate over public infrastructure using a virtual private network (VPN), or other similar techniques, which allow only authorized computing devices to communicate on the service provider network 105. A service provider (e.g., a money lender, a university application service, an employment application service) offer certain services requiring users to input data on prescribed forms. Devices 111, 113, 115 and software tools of the service provider network 105 may then process and/or store the information received from the client device 101. In some implementations, the service provider is expected to generate a result or provide a product, such as determining whether a lender will loan money, deciding whether a university should offer admission to an applicant, or sending a shipment for a purchased product. In some implementations, the service provider operates as an information intake that gathers and processes data on behalf of another entity. For example, the service provider may administer loan applications for determining an applicant's credit health on behalf of a lender, the processed information is forwarded to the lender who later determines whether to disperse the loan. In another example, the service provider may administer admissions applications for gathering qualifications and profile data of an applicant on behalf of a university, the information may be processed and forwarded to staff members who later determine whether to grant admission.

In some embodiments, a service provider network 105 comprises a web server 111 that communicates with client devices 101 and functions as an interface between the service provider network 105 and various external devices outside of the service provider network 105. The web server 111 may be any computing device comprising a processor and non-transitory machine-readable storage memory capable of performing the various tasks and processes described herein. In some embodiments, the web server 111 may host a website for receiving information from users' client devices 101. In some embodiments, the web server 111 may establish a connection with a dedicated software application residing on users' client devices 101, as in some software-as-a-service environments. The web server 111 may receive information from client devices 101 and then transmit that data to a central server 113. It should be appreciated that the web server 111 and the central server may be the same physical device in some embodiments. The web server 111 may parse information into data elements, or may receive a stream of data elements from the client device 101. In some embodiments, the web server 111 may establish an ongoing connection or otherwise execute software modules facilitating real-time capture of information inputted into the form by the user.

A central server 113 may be any computing device comprising a processor and memory capable of performing various processes and tasks described herein. In some embodiments, the central server 113 may host or execute software tools utilized by the service provider to provide the intended service offering. For example, the central server 113 of a bank or financial lender may execute loan origination software modules that utilize the information received from a client device 101 to determine whether to the lender will disperse a loan to a user who is applying for the loan. Other examples of software modules executed by the central server 113 may include processing university applications, merchandise or inventory order forms, and other similar software modules receiving user information in discrete data fields.

In some embodiments, the central server 113 may receive information from a user's client device 101 directly. The client device 101 may execute software modules associated with a software product, such as a cloud-based or software-as-a-service application, which is administered centrally by service provider using the central server 113. The software module of the client device 101 may then communicate submitted information to the associated software modules of the central server 113. In some embodiments, the central server 113 may be communicatively coupled to a web server 111 that hosts a website, or a dedicated software application of the service provider, which receives information inputted from the client device 101. The information submitted by users into a form's data fields using his or her client device 101, may be captured by the web server 111 and then forwarded to the central server 113. In some embodiments, the web server 111 may parse information into data elements; and, in some embodiments, the central server 113 may parse the information into data elements. In some embodiments, the central server 113 may be communicatively coupled to a service provider's internal database 115, into which the central server 113 may store information submitted by a user.

A service provider network 105 may comprise a provider internal database 115, which may store data associated with customers and other business data. The internal database may reside on any computing device comprising processors, non-transitory machine-readable storage media, and software modules capable of performing the various tasks and processes described herein. The internal database 115 may be one or more distinct physical devices, which are dedicated to hosting the internal database 115, or the internal database 115 may share one or more physical computing devices with one or more other servers 111, 113. The internal database 115 may store records containing information about users who may be submitting data elements to the service provider through a web form. In some implementations, the internal database 115 records may be retrieved and consulted to confirm user identities and to verify the information received from the user's client device 101.

Data Verification Service

The system 100 may comprise a verifier network 107 utilized by a verification service that reviews and verifies information submitted by users to a service provider. The verifier network 107 may comprise computing devices and software modules that may receive data elements, over a network 103, from computing devices of the service provider network 105, and then review, process, and verify the information contained within those data elements. The verification service may be separate entity or the verification service may be an affiliate of the service provider. As such, it should be appreciated that the verifier network 107 and the service provider network 105 may operate as an integrated private network; or the verifier network 107 and the service provider network 105 may be distinct private networks, as shown in FIG. 1.

The verifier network 107 may be a collection of networked computing devices privately communicating with one another using one or more networking protocols (e.g. TCP/IP) and networking devices (e.g., router, switch, firewall). The verifier network 107 may be a private network implementing various security techniques (e.g., encryption, VPN connections, firewalls) permitting only certain computing devices to communicate over the verifier network 107, such computing devices may include the verifier devices 117, 119, 121. It should be appreciated that the verifier devices 117, 119, 121 may be a single physical computing device, or the verifier devices 117, 119, 121 may be distributed in any number of permutations among several physical computing devices. The verifier network 107 may comprise computing devices located at a number of physical locations, and thus the verifier network 107 may represent logical boundaries of an internal network, i.e., the verifier network 107. That is, authorized computing devices, such as the verifier devices 117, 119, 121, may be geographically dispersed and thus communicate over public infrastructure using VPN, or similar techniques.

A verifier server 117 may receive and verify data elements transmitted from a computing device of a service provider network 105 over a network 103. The verifier server 117 may be any computing device comprising a processor and non-transitory machine-readable storage media capable of performing the various tasks and processes described herein. The verifier server 117 may be communicatively coupled to one or more external databases 109, which may store records containing information about a user who submitted data elements to the service provider and/or records containing information about a transaction involving the user. In some embodiments, the verifier server 117 may be communicatively coupled to an aggregation database 119 that stores an ongoing set of records relating to the various data elements that have verified based on the records retrieved from the external databases 109. In some embodiments, the verifier server 117 may be communicatively coupled to an authentication server 121 to determine whether a user, who may be a customer or a service provider's representative, is authorized to access the information submission form.

The verifier server 117 may execute software modules that request a set of records from external databases 109. The records may contain information about a transaction and/or information about a user who is involved in that transaction. In some embodiments, the verifier server 117 may request records about the transaction and/or about the user from a service provider's internal database 115 (e.g., customer accounts, customer profiles). In some embodiments, the verifier server may request records about the user from an aggregation database 119. The verifier server 117 may determine whether the submitted information agrees with the records obtained from the external databases 109. In some embodiments, automated processes and/or administrative selections may provide settings to the verifier server 117 used for verifying data elements. For example, personnel from the service provider may indicate to an administrator of the verifier server 117 a threshold value (e.g., a percentage change or number of characters that are different between inputted data and a record of an external database) for identifying disagreement or discrepancy between the information in records obtained from external databases 109 when compared against user-submitted information. In another example of settings, the verifier server 117 may identify an appropriate means for formatting and responding to a client device 101 that recently submitted a web form or data elements. It should be appreciated that these examples are not intended to be limiting upon the means by which these settings are established and maintained. For example, settings may be manually input into the verifier server 117 and then automatically adjusted based on performance feedback, i.e., too sensitive to discrepancies or too relaxed on discrepancies.

In some embodiments, the verifier server 117 may be capable generating one or more data elements from user-submitted information as needed through parsing, concatenating, and/or re-parsing the user-submitted information. The verifier server 117 may identify types of data in database records and in form fields. Records may comprise one or more fields storing information that may be categorized by field according to the type of information intended for each field (e.g., account no., first name, address, data of birth). Correspondingly, forms may comprise fields that prompt users for information of a particular type. In some cases, the user-submitted information from the form field results in a data element that does not precisely align with a record obtained from an external database 109. The verifier server 117 may resolve this by recognizing the same information in both the data elements and the record, and then parsing the data elements accordingly.

In some embodiments, the system 100 may comprise an aggregation database 119 communicatively coupled to a verifier server 117. An aggregation database may store ongoing records containing information about particular users, property, accounts, and other data based on the nature of the information retrieved from the external databases 109. In some cases, the aggregation database 119 may operate in a caching capacity allowing the verifier server 117 to quickly reference information culled from external databases without having to pull from those databases for every data element input by the user. For example, in a real-time verification embodiment in which each form field is verified as soon as the user moves to a new form field, rather than submitting a new database query to each external database 109 each time the user highlights a new form field, it may be more efficient for the verifier server 117 to pull whole records and store them into the aggregation database 119 for quicker reference. In some implementations, the aggregation database 119 may operate as a baseline or control for information comparisons, which may be updated periodically or upon identifying a discrepancy that is adequately resolved because the information from an external database 119 is outdated. The aggregation database 119 may serve as a baseline for determining appropriate relationships among data fields of records, and may be cross-referenced against other database records to determine whether there are any discrepancies in the user-submitted information.

In some embodiments, the system 100 may comprise an authentication server 121 communicatively coupled to a verifier server 117 and/or a web server 111. The authentication server 117 may generate a predefined set of authenticating questions to be presented on the client device 101 of the user. The authentication server 117 electronically sources questions by retrieving information over a network from external databases 109 for questions that cannot be answered by referring to a user's wallet, or out-of-wallet questions, which might include questions related to a previous address, previous phone number, and previous employers. Out-of-wallet questions do not rely on personal information that is typically found in a wallet, card, or desk. The authentication server 117 may generate questions based on information obtained from external databases 109, such as public records and commercially available databases, which may result in questions whose answer choices are unique to each individual user. This combination can reduce the ability for someone other than the genuine user to provide correct responses. In some embodiments, the authentication server 117 may be configured to address high-risk identities and/or high-risk transactions by adjusting the difficulty of the questions during the authentication process. Some identity events that may be measured for high-risk may include: public record searches; suspicious access to a user's public record reports; and the frequency and recentness of previous identity searches.

External Public and Private Data Sources

External databases 109 may store records containing information about users, property, and other aspects of transactions involving users. External databases 109 may be public databases and/or private databases residing outside of the boundaries of a private network 105, 107 of the system 100. Public databases may store information relating to public record, such as a municipality's real property database 109a, a state's corporate registry 109b, a criminal database, or the like. Private databases may store information relating to an entity's operations or other proprietary information, such as the server provider's internal database 115, a corporate database (e.g., human resource database, customer profile database), a subscription service database (e.g., LexisNexis®), and the like. Databases 109 may be referenced by a verifier server 117 and/or an authentication server 121 to perform their various processes and tasks.

Example Use Case of a System

The methods and systems described herein can perform quality control during the application process for entering information into a form to submit for a lender to review. In this exemplary implementation, a user may be an applicant for a bank loan administered by a lender that is acting as a service provider. As the applicant enters information into a software-based form capturing information input (e.g., Form 1003 loan application), the system can instantly verify and correct the applicant's information. As a result, these methods and systems can eliminate applicant call-back and a need to search for missing documents. Additionally, these methods and systems can eliminate false fraud alerts and wasted research.

In this exemplary implementation, the applicant for a bank loan (e.g., a car loan, a mortgage) may use a web-browser on his or her client device 101 in order to access a website of the lender that administers a web form for applying for the bank loan. The process from receiving a loan application to disbursal of funds or declining the application is known as loan origination. In this example, the lender's network 105 may host a devices and software modules of a loan origination system that processes loan applications. The applicant may enter information into a web form hosted on a web server 111 prompts the applicant for the requisite information for completing the loan application. The client device 101 may communicate the information over a network 103a to the lender's webserver 111 of the lender's network 105, either after the form is completed or in real-time (i.e., one data element at a time). In this example, the applicant may use his or her smartphone 101b to complete and/or submit the loan application to the web server 111. This example should not be construed as limiting on the client device 101. In other examples, the user may operate an ATM to submit the loan application, an Internet TV to submit the loan application, or a tablet computer to submit the loan application. In some cases, the client device 101 is not a computing device owned or possessed by the applicant. For example, the applicant may communicate with the lender's network 105 using a device at a bank branch (e.g., ATM), a store, a library, an Internet café, a shopping mall, and that device may communicate with the lender's network 105 via a public network 103a (e.g., Internet, direct line, or asynchronous transmission network).

The smartphone 101b of an applicant who is applying for a bank loan may communicate over a network 103a with the lender's network 105 through the lender's web server 111. The lender's web server 111 may receive data elements from the smartphone 101b as the user fills in each field of the form. The web server 111 then forwards to a central server 113, which may execute software for processing loan applications. The central server 113 may also be coupled to a lender records database 115 that stores existing customer information, applicant information, and loan information.

During loan origination, loan origination software modules executed by the central server 113 may obtain data records over a network 103c from a plurality of external databases 109. The external databases 109 may be public and/or private databases 109 storing records containing information about the applicant and information about the user's intended loan transaction. In one example, a first external database 109b may provide data regarding property information, and a second external database 109c may provide data regarding a credit score of the applicant. In some cases, the loan origination processes performed by the central server 113 may be operated and managed by a third party other than the lender. In such cases, the loan origination modules may reside on a different physical device from the the central server 113 and may have access to the lender's network 105. Additionally or alternatively, the third party may be provided access to loan origination modules hosted by the central server 113.

In this example, the lender contracts with a verification service providing quality control software modules executed by a verifier server 117. That is, the verifier server 117 may provide quality control functions for reviewing and verifying information submitted from users. The verifier server 117 may communicate with an authentication server 121. It should be appreciated that the verifier server and the authentication server may be the same physical computing device, or they may be multiple computing devices. In some embodiments, the verifier server 117 may also be an application server executing various computing services that accept information submitted by users though client devices 101. During loan origination, the central server 113 of the lender's network 105 may communicate with the loan origination modules of a central server 113, and the central server 113 may also communicate over network 103c with the verifier server 117.

When the applicant has completed the application, a loan officer can instantly view the application and the results of any changes or identified issues, which may presented by a web server 111 to a client device 101 associated the loan officer. The loan officer can discuss these changes or issues with the applicant and approve the application at the loan officer's discretion. Once the application is complete and correct, the application is ready for the applicant's signature. The applicant does not need to return with extra documents, a fraud check at underwriting will not be clouded by honest errors, and the underwriter can focus on true fraud issues. As a result, the methods and systems can offer reduced frustration for the borrower, a shorter loan processing cycle, and lower processing, underwriting, compliance, and secondary costs.

In an alternative embodiment, a completed application can be returned to the applicant in addition to or instead of providing the completed application to the loan officer. The completed application can be provided by a central server 113 or web server 111 to the applicant's computer 101a or smartphone 101b in an editable format, such as a word processing document (e.g., Word® ‘.doc’ file). The lender's central server 113 may allow the applicant to select whether to submit the application to the loan officer or to provide it only to the applicant. Optionally, based upon whether the completed application is going to be provided to the applicant, loan officer, or both, the system can make decisions on how much or how little corrections to offer. Using preferences or requirements of the applicant or lender, the system may vary a limit on how much to accommodate discrepancies in the applicant's answers or types of suggestions or responses given to the applicant to address those discrepancies.

### Exemplary Method Embodiment

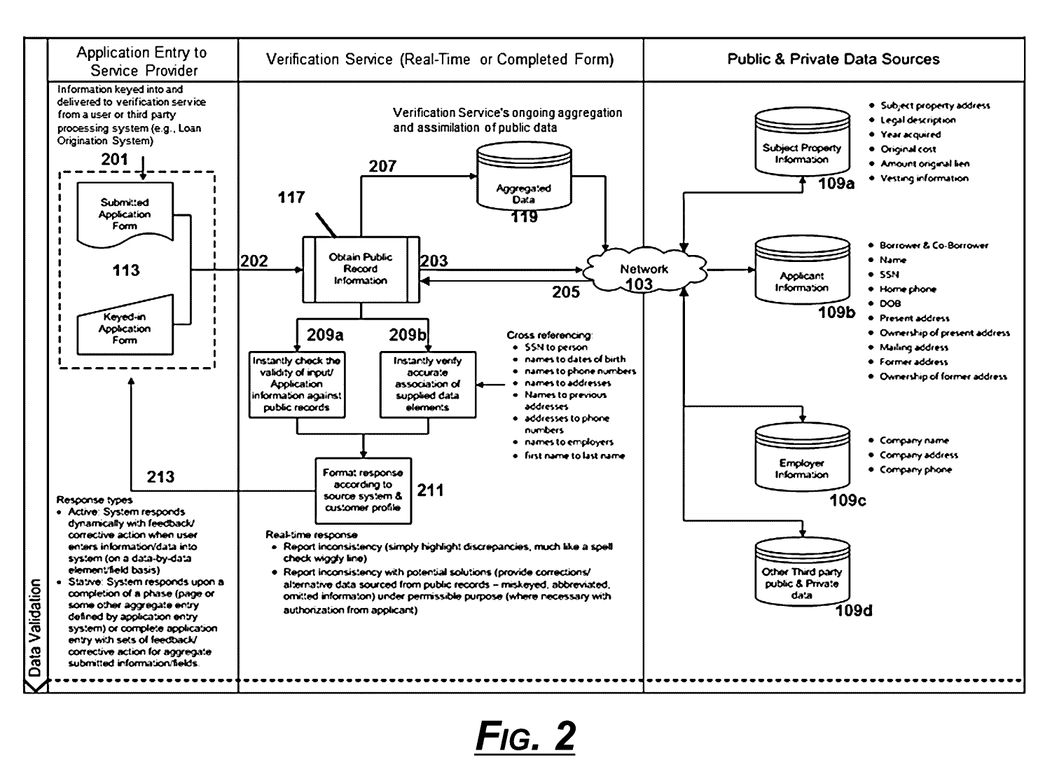

FIG. 2 shows various steps performed by processors and software modules in an information review and quality control system, according to an exemplary method embodiment. The description of FIG. 2 recites information submission and review for a loan origination implementation. However, it should be appreciated that this is just one of many possible implementations of the systems and methods described herein, and thus the exemplary implementation should not be construed as limiting upon the technical features described herein.

In a first step 201, an applicant provides information to a lender's central server 113, which may be keyed-in by the applicant or by a representative of the lender (e.g., loan officer, administrator). In a next step 202, the keyed-in information may be transmitted to a verifier server 117 (also referred to as a quality control server 117 in FIG. 2) from a loan origination system's central server 113 executing loan origination software modules. As an alternative to transmitting the information as it is keyed-in (i.e., real-time submission and review), an application form presented to a client device 101 may be submitted to the central server 113 after the applicant or the representative attempts to complete the requisite fields.

In a next step 203, the quality control server 117 may obtain public record information from one or more external databases 109. The quality control server 117 may fetch information from the external databases 109 through a network 103. The quality control server 117 may submit database queries, or other forms information requests, over a network 103 to the external databases 109 in order to fetch the information from those external databases 109. For example, one database 109a may provide subject property information, such as a subject property address, legal description, year acquired, original cost, amount of original lien, and vesting information. Another database 109b may provide applicant information, such as borrower and co-borrower, name, social security number, home phone, date of birth, present address, ownership of present address, mailing address, former address, and ownership of former address. Another database 109c may provide employer information, such as company name, company address, and company phone. Other third party public and provide databases 109d may also be used.

In a next step 205, the requested information is transmitted from the databases 109 back to the quality control server 117 through the network 103.

In a next step 207, the quality control server 117 may store one or more records of information received from external databases 109 into an on-going aggregation and assimilation database 119.

In a next step 209a, the quality control server 117 may instantly check the validity of the inputted application information (received from a client device 101) against public and private records (received from external databases 109). In a next step 209b, the quality control server also instantly verifies accurate association of supplied data elements from the client device 101 and/or the records from the external databases 109. For example, the quality control server 117 may cross-reference a social security number to a person, names to dates of birth, names to phone numbers, names to addresses, names to previous addresses, addresses to phone numbers, names to employers, and first name to last name. In one example, the quality control server 117 can use an inputted address from the client device 101 to determine whether the address matches a phone number associated with that address in a retrieved record. The quality control server 117 may notify the applicant or the representative who submitted the information on behalf of the applicant regarding the unmatched information in that particular received piece of information, or data element. It should be appreciated that these discrepancy determination steps 209 may be performed simultaneously or near-simultaneously, or in succession; it should be appreciated that these steps 209 may be performed interchangeably in their order.

In some embodiments, the quality control server 117 may employ algorithms that may calculate a match quality for a potential match between information of a data element received from the applicant and the information of a record received from an external database 109. The quality control server may determine which received record is a best match for user-submitted information in order to accommodate for unintended discrepancies between the information of the retrieved records and the user-submitted data elements. The quality control server 117 may also utilize records in an internal database 115 of the lender and/or an aggregation database 119.

In a next step 211, the quality control server 117 may generate and format a response according to desired settings of an administrator, a customer profile, and/or as determined by automated processes that may detect software modules of the client device 101.

In a next step 213, the formatted response may be transmitted in real-time by the quality control server 117, back to a central server 113 of the lender (i.e., the loan origination server). The response can report or indicate inconsistencies to an applicant or a loan office. For example, the response can indicate discrepancies by highlighting or underlining discrepancies. The response can also report or indicate inconsistencies along with potential solutions, such as by providing corrections using alternative data sourced from public records for miskeyed, abbreviated, and omitted information, and when done under permissible purpose (i.e., where necessary with authorization from the applicant). In some embodiments, the central server 113 may generate a response incorporating a request for further information if, in returning the correct information, the response might facilitate the risk of fraud.

The response can be active or stative. For an active response, the quality control server 117 can respond dynamically with feedback or corrective action when the user enters information or data into the system (e.g., on a data-by-data element basis, or on a field basis). For example, after entering a street name, the quality control server 117 may respond dynamically with feedback or corrective action. In another example, after entering the entire address, the quality control server 117 may respond dynamically with feedback or corrective action. In yet another example, as the applicant or representative enters a street name, the quality control server 117 can respond dynamically with feedback or corrective action. In some embodiments, the quality control server 117 can identify possible solutions from the records pulled from external databases 109 and/or an aggregation database 119 and then list the possible solutions for any item, as long as it does not promote fraud.

For a stative response, the quality control server 117 can respond upon completion of a phase of an application (e.g., a page or some other aggregate entry defined by an application entry system) or upon completion of an entire application. The quality control server 117 may provide the client device 101 with sets of feedback or correction action for aggregated submitted information or fields. For example, the quality control server 117 can respond upon completion of residential address information or completion of employer information. In another example, the quality control server 117 can respond upon completion of each page.

In one example, the quality control server 117 can be configured to provide responsive feedback when the applicant or representative has inputted a property characteristic (e.g., house number, street name, street suffix, postal direction, apartment, city, state, and zip code), when the applicant or representative enters all of the property characteristics, or when the applicant or representative enters all property information, including property characteristics and financial information about the property (e.g., refinance information). In one embodiment, whether the inputted fields are verified as they are inputted, verified after each field is inputted, or verified after a plurality of fields are inputted, the quality control server 117 can use a first color (e.g., green) to indicate which fields match public records and a second color (e.g., red) or indication (e.g., symbol, highlighting, font) to indicate which fields do not match public records.

The quality control server 117 may instantly verify information submitted in the various data element fields of an application. For example, the quality control server 117 can instantly verify eighty-two (82) data elements in response to an applicant's submission of a Form 1003, including, but not limited to data fields relating to subject property information (e.g., subject property address, legal description, year acquired, original cost, amount of original lien, vesting information), borrower information (borrower and co-borrower, name, social security number, home phone, date of birth, present address, ownership of present address, mailing address, former address, ownership of former address, and employer information (e.g., company name, company address, company phone). The quality control server 117 may use public and private records retrieved from external databases 109 to verify an applicant's submitted information and to provide an applicant or representative with identified issues for resolution, which may be presented on a graphical user interface of a client device 101 associated with the applicant or representative. For example, a conventional system may not recognize that a woman has a different name due to a recent marriage, but algorithms implemented by embodiments of the quality control server 117 (i.e., verifier server 117) may present to the applicant or representative that the applicant's name is now different due to a marriage.

### Exemplary User Interface

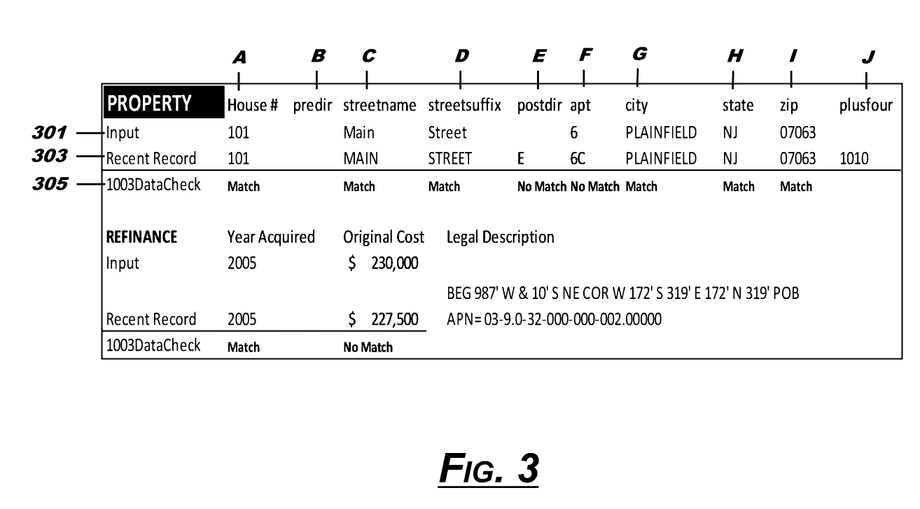

FIG. 3 shows an exemplary graphical user interface according to an exemplary embodiment. An applicant's or the representative's computing device may execute software modules displaying a graphical user interface. FIG. 3 displays a response generated by a quality control server after the quality control server checked inputted information against public records retrieved from external databases.

In this exemplary embodiment, user-inputted information 301 about a property has been inputted as 101 Main Street, Apartment 6, Plainfield, NJ 09063. The quality control server may attempt to match each field 301a-j, or data type, corresponding to fields 303a-j of a public record 303. The quality control server may identify discrepancies based upon comparisons between the information of the public record 303 and the input 301. For example, the quality control server may respond that the input postal direction 301e should contain an “E” (for East), and thus the input for that field 301e does not match the record 303e. In some embodiments, the quality control server responds that the apartment no. field F should contain “6C,” as indicated by the public record apartment no. 303f, instead of “6,” as inputted by the user for that data field 301f. Accordingly, the graphical user interface identifies the results of a data check 305, which may indicate unmatched fields 305e, 305f. An applicant or representative may determine that these fields can be corrected because the inputted information likely miskeyed, abbreviated, or inadvertently omitted this information. In some embodiments, the quality control server may calculate a likelihood that the information was miskeyed, abbreviated, or inadvertently omitted on behalf of the applicant or representative.

In another example, the quality control server identifies that inputted information in an application indicates a refinancing in 2005 for $230,000. However, based upon checking a database, the quality control server identifies that the refinancing in 2005 was actually for $227,050. Accordingly, the graphical user interface identifies where there is no match for these fields. Automated processes calculating a likelihood of error, or an applicant or representative may determine that these fields can be corrected because the inputted information likely inadvertently rounded this information.

### Authentication Services

The systems and methods may work to ensure security and protection of the consumers' private information. The system may employ one of variety of techniques that automatically authenticate a person's identity before granting a client device access to valuable information or granting the ability to perform various transactions remotely. In one example, a server, such as a service provider's central server or web server, may utilize knowledge based authentication (KBA) identity authentication techniques. Although the exemplary embodiment recites the use of KBA, the system can use one or more remote identity verification schemes. For example, the system can use facial recognition software, fingerprint scan, retina scan, or any other biometric authentication methods or other trusted methods. The exemplary embodiment utilizes an identity challenge, but it is not intended to be limited to only the use of KBA.

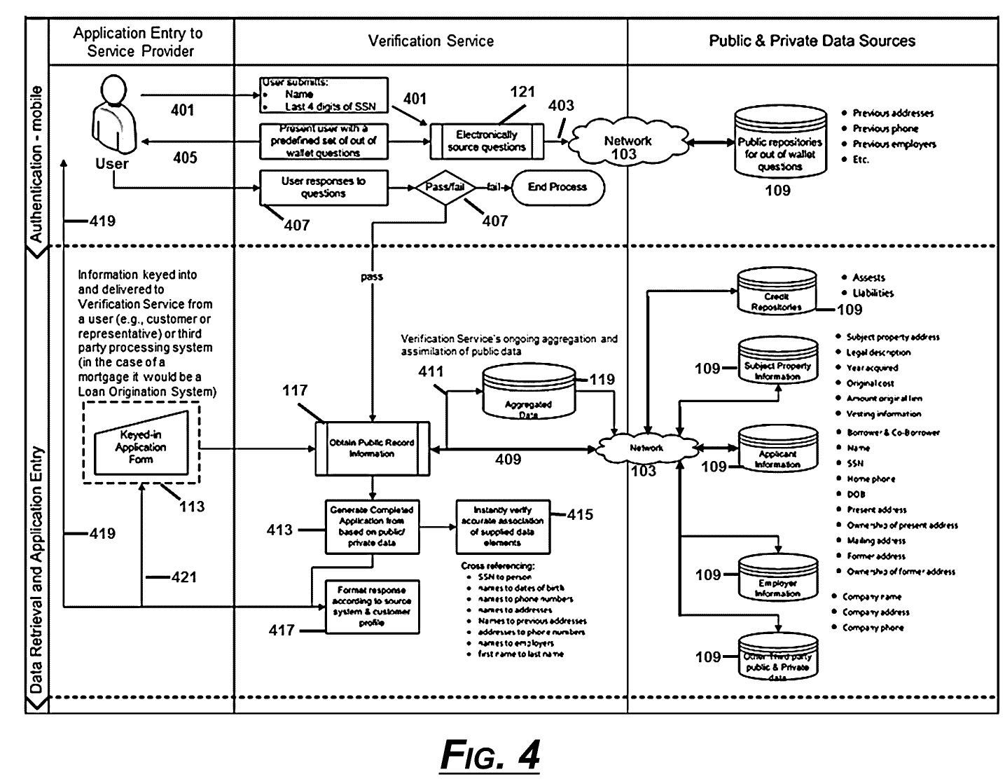

FIG. 4 may show steps for applicant authentication and application completion, according to an exemplary method embodiment. In this example, an authentication server 121 uses information from external databases 109 to generate questions challenging the user's identity. The user may interact directly with a webserver 111, but the webserver 111 may function as the interface between the user's client device 101 and the authentication server 121.

In a first step 401, an applicant submits information to an authentication server 121, such as his or her name and the last four digits of his/her social security number using a mobile computing device. The applicant may enter a limited amount of identifying information, such as their name and the last four digits of their social security number, into a user interface on the computing device 101. This information can be securely transmitted to the authentication server 121.

In a next step 403, the authentication server 121 may reference records containing outdated information from external databases 109 to generate out-of-wallet questions using the information submitted by the user. The authentication server 121 may identify certain types of information that may be known only to the user. The questions may be more or less difficulty based upon how far back the information is dated and what type of user response is expected (e.g., multiple choice, text-string entry).

In a next step 405, an authentication server may present the user with a series of questions. In one example of KBA, the authentication server 121 can respond by transmitting four multiple choice questions to the applicant's client device 101. In determining the types of questions, the lender's administrative staff may configure the authentication server 121 by choosing a level of difficulty, the number of questions, and the correct response ratio and the number of alternate questions.

In a next step 407, the authentication server 121 determines whether the user's responses to the generated questions are correct. The authentication server 121 may end the login process, and effectively lockout the user if the user fails to answer the questions within a set number of attempts. The authentication server 121 may also permit the client device 101 of the user to access a quality control server 117 if the user accurately answers the questions.

In one embodiment, the system can utilize a third party as part of the identity challenge by returning a form for a pre-approved loan officer to attest to the applicant's identity by importing a photo from the mobile computing device and a photo of a government issued photo ID of the applicant. The system identity challenge may require that an application be accepted by a certified individual that attests that they are dealing with the actual person submitting the application. The applicant may submit an electronic copy of a government issued identification card. In one embodiment, the applicant may be prompted to take a picture of themselves and the server can employ facial recognition techniques as part of the identity challenge.

Once the identity of the applicant has been verified, the server can present the applicant with an opportunity to digitally sign an authorization for the system to access the applicant's private records, such as full SSN, DOB, address, employment, income, and a consumer credit report. The system can then request information from public and private databases to complete a detailed and/or lengthy personal application (e.g., Form 1003) on behalf of the applicant. Using a secure, encrypted connection with the system, the applicant can use the mobile computing device to review, edit, and electronically sign the automatically competed application.

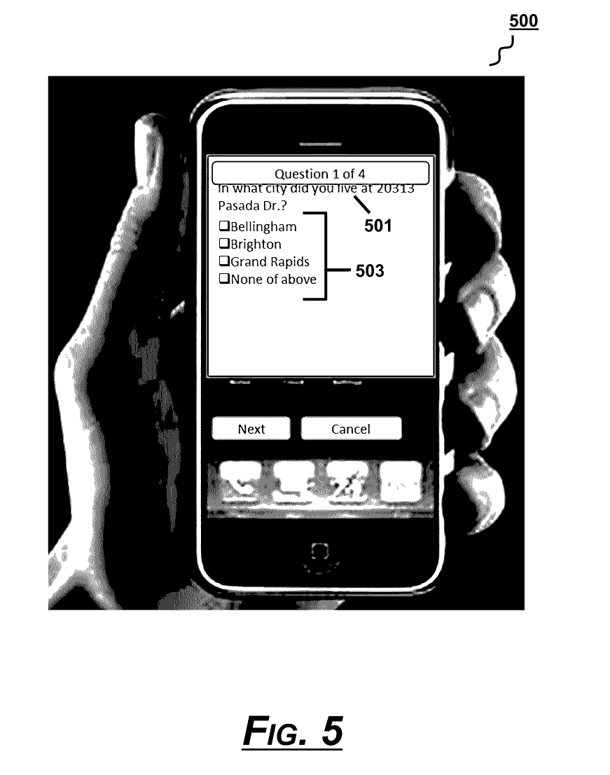

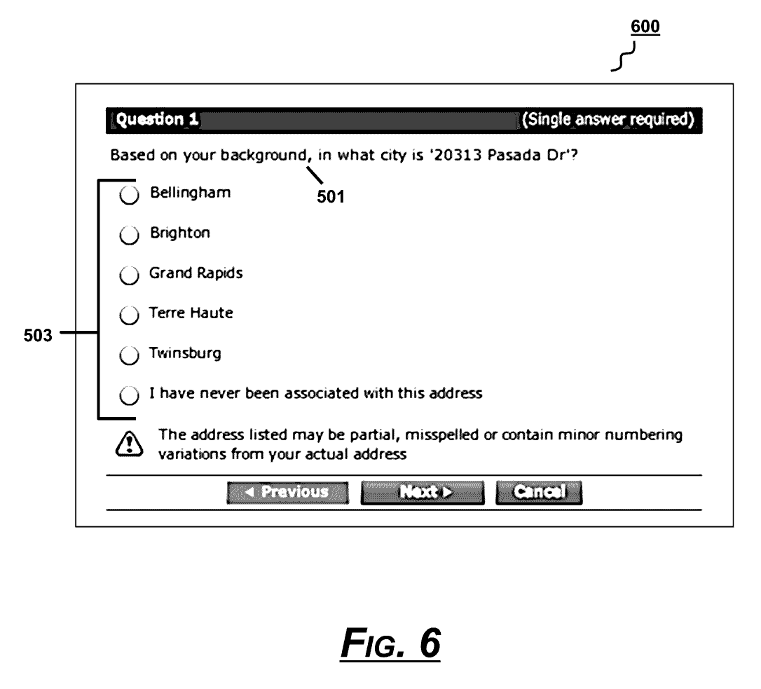

For example, as shown in FIG. 5, a user interface 500 on a mobile computing device presents a question 501 to the applicant of “In what city did you live at 20313 Pasada Dr.?,” with multiple choices 503 including Bellingham, Brighton, Grand Rapids, and None of the Above. FIG. 6 shows an alternative user interface 600, which may be displayed on a tablet computer or personal computer. In both exemplary embodiments, the applicant responds to all of the questions. If the responses are incorrect, the applicant is not authenticated. If the responses are correct, the applicant is authenticated and the authentication server may instruct the web server to redirect the client device to a verifier server.

Referring back to FIG. 4, in this exemplary method of identity verification 400, the process 400 may be conducted in real-time. In such embodiments, execution of step 407 by an authentication server 121 may provide a simple “pass/fail” result can be delivered instantly to other devices in the system. No prior relationship with the applicant is required. Even if an organization has no prior relationship with the applicant, questions can be developed by submitting the basic information. In some embodiments, intelligent fact-ranking algorithms may help legitimate users from failing the authentication process due to faulty human-memory by offering one alternate question.

In a next step 409, when the applicant is authenticated, a quality control server 117 obtains public record information from external databases 109. The quality control server 117 submits requests over a network 103 from external databases 109. For example, one database may provide subject property information, such as a subject property address, legal description, year acquired, original cost, amount of original lien, and vesting information. Another database may provide applicant information, such as borrower and co-borrower, name, social security number, home phone, date of birth, present address, ownership of present address, mailing address, former address, and ownership of former address. Another database may provide employer information, such as company name, company address, and company phone. Other third party public and provide databases may also be used. The requested information is transmitted through the network back to the application server.

In a next step 411, the quality control server 117 can store an on-going aggregation and assimilation of private and public data retrieved from external databases 109 into an aggregation database 119 associated with the quality control server 117.

In a next step 413, the quality control server 117 automatically generates a completed application form (i.e., a computer file representing a hardcopy institutional form) based upon the received public and private data.

In a next step 415, the quality control server 117 may instantly verify accurate association of supplied data elements. For example, the quality control server 117 may cross-reference a social security number to a person, names to dates of birth, names to phone numbers, names to addresses, names to previous addresses, addresses to phone numbers, names to employers, and first name to last name.

In a next step 417, the quality control server 117 generates and formats a response according to desired settings of an administrator and/or a customer profile.

In a next step 419, a computer file containing the application form may be returned to a client device 101 in an editable format such that information may be entered by user directly into an application.

In a next step 421, after the user enters the information, the application can be transmitted to a central server 113 having loan origination software for the information to be entered into a mortgage application. That is, after the applicant views, edits, and electronically signs an electronic version of the application, and after a loan officer attests to the identity of the applicant, computer file containing a completed application can be sent to the lender.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “transmitting” or “determining” or “authenticating” or “selecting” or “displaying” or “identifying” or “verifying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general-purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

What is claimed is:

1. A computer-implemented method comprising:
receiving, by a computer, from a first computing device one or more data elements containing information about a person associated with a transaction;
retrieving, by the computer, one or more records containing information about the person from two or more databases storing records containing information about one or more persons, wherein at least one of the two or more databases is an external database;
comparing, by the computer, the information in each of the one or more data elements against the information contained in the one or more records;
determining, by the computer, whether the information in each respective data element matches to the information contained in the one or more records;
for each respective data element containing information failing to match to the information in the one or more records:
identifying, by the computer, a discrepancy in the information of the data element when a difference between the information in the data element and the one or more records exceeds a threshold; and
responsive to the computer determining that each respective data element contains information matching the information in the one or more records:
automatically generating, by the computer, a machine-readable intake file, the intake file containing the information corresponding to each respective data element; and
transmitting, by the computer, the intake file one or more assessment servers configured to review the information in the one or more data elements of the intake file.

2. The method according to claim 1, wherein comparing each respective data element against the one or more records further comprises:
cross-referencing, by the computer, a first data element containing information of a first type to a field of a record containing information of a second type.

3. The method according to claim 2, further comprising determining, by the computer, whether the information of the second type in the field of the record matches to information of the second type contained in a second data element.

4. The method according to claim 1, further comprising determining, by the computer, a strength of a match based a number of identified discrepancies, wherein the record fails to match the one or more data elements in response to determining the number identified discrepancies exceeds a second discrepancy threshold.

5. The method according to claim 1, further comprising determining, by the computer, a strength of a match based upon one or more matches of one or more fields of a record compared to each respective data element.

6. The method according to claim 1, further comprising:
generating, by the computer, a response indicating the one or more discrepancies; and
transmitting, by the computer, the response to the client computing device.

7. The method according to claim 6, further comprising formatting, by the computer, the response based on a type of device of the client device.

8. The method according to claim 6, further comprising formatting, by the computer, the response based upon a type of software service associated with the computer and the client device.

9. The method according to claim 1, further comprising calculating, by the computer, a match strength of a match between a first data element containing information of one or more types and a record having one or more fields containing information of the one or more types.

10. The method according to claim 9, further comprising determining, by the computer, a best match in the one or more records based on a comparison of the match strengths calculate for the one or more records.

11. The method according to claim 1, further comprising automatically providing, by the computer, a response indicating a discrepancy to the client device upon identifying the discrepancy.

12. The method according to claim 1, further comprising:
receiving, by the computer, a computer file containing a set of one or more data elements containing information about the person and the transaction; and
parsing, by the computer, the set of data elements into the one or more data elements.

13. The method according to claim 1, further comprising automatically generating, by the computer, a computer file containing a digital version of an application form using the records retrieved from the one or more external databases.

14. The method according to claim 1, further comprising automatically updating, by the computer, an aggregation record for the person stored in an aggregation database.

15. The method according to claim 14, further comprising wherein retrieving the one or more records of the external databases further comprises: retrieving, by the computer, one or more aggregation records of the person stored in the aggregation database.

16. A system comprising:
a client device comprising a processor transmitting over a network one or more data elements containing information about a person entered into one or more fields of a form on a user interface;
two or more external databases comprising a non-transitory machine-readable storage medium storing records containing information about one or more persons; and
a verification server comprising a processor receiving the one or more elements transmitted from the client device, retrieving one or more records containing information about the person from the two or more databases, determining whether the information in one or more fields of each respective record matches with each respective data element, identifying one or more unmatched data elements containing information failing to match a field of the one or more records, for each unmatched data element: determining whether there is a discrepancy indicating that a difference between an unmatched data element and the data element in the record exceeds a discrepancy threshold, and upon determining that each respective data element contains information matching the information in the one or more records: automatically generating a machine-readable intake file containing the information corresponding to each respective data element, and transmitting the intake file to one or more assessment servers configured to assess the intake file generated by the verification server.

17. The system according to claim 16, further comprising an authentication server comprising a processor receiving a set of data elements from the client device identifying a user, fetching at least one record containing information about the user from at least one external database, and generating a set of authentication questions using information about the user extracted from the at least one record.

18. The system according to claim 16,
wherein the verification server generates a computer file containing a digital version of a form, populates the form using the data elements received transmitted by the client device, and transmits the computer file to the client device, and
wherein each respective data element entered into one or more fields of a computer-based data entry form maps to a field of the form in the computer file.

19. The system according to claim 16, wherein the verification server automatically receives each respective data element sequentially from the client computer upon entry of information into the data element, and wherein the verification automatically provides a response indicate a number of discrepancies.

20. The system according to claim 16, wherein the verification server calculates a match strength for a match between the information in a data element and the information in one or more fields of a record.

21. The system according to claim 20, wherein the verification server identifies a best matching record based on a comparison of the respective match strengths of the one or more records.

22. The system according to claim 21, wherein the response generated by the verification server further comprises at least a portion of the information contained in the best matching record.
